(19) United States
(12) Patent Application Publication
(10) Pub. No.: US 2025/0242849 A1
(43) Pub. Date: Jul. 31, 2025

(54) Enclosure Cart for Cooling Solutions

(71) Applicant: Ice Qube, Inc., Greensburg, PA (US)

(72) Inventors: Ridge Altman, Greensburg, PA (US); Jared Skoloda, Greensburg, PA (US)

(73) Assignee: Ice Qube, Inc., Greensburg, PA (US)

(21) Appl. No.: 19/037,406

(22) Filed: Jan. 27, 2025

Related U.S. Application Data
(60) Provisional application No. 63/625,264, filed on Jan. 25, 2024.

(51) Int. Cl. B62B 3/02; B62B 5/00

(52) U.S. Cl. CPC B62B 3/02; B62B 5/0093; B62B 2206/003; B62B 2206/06; B62B 2301/10

(57) ABSTRACT

An enclosure cart is described. An enclosure cart may include retractable arms or legs along with leveling casters. The enclosure cart may be used to secure and position an enclosure for cooling, such as a network enclosure. The network enclosure may include cooling unit(s), such as an air conditioner. The enclosure cart may be supplied with the enclosure. The enclosure cart may be reused after the enclosure is mounted into place.

### CROSS-REFERENCE TO RELATED APPLICATIONS

This application claims priority to U.S. provisional patent application Ser. No. 63/625,264, having the same title and filed on Jan. 25, 2024, the contents of which are incorporated by reference in their entirety.

### BACKGROUND

Industry and manufacturing have emerged with the widespread use of enclosures for a variety of content, for example electronics or other items that require protection from the elements as well as cooling. For example, to protect these items from harsh environments, items are typically placed in sealed enclosures or cabinets that permit efficient operation without the threat of being exposed to exterior contaminates including dust, residue, rain and liquids that have the potential to cause serious damage. Since the items (such as electronics or like equipment) often generate heat within the enclosure, various cooling equipment such as air conditioners, heat exchangers, in-line compressed air coolers and filtered fan systems are used to maintain required operating temperatures within the enclosure.

Certain cooling systems often treat the enclosed air only, while sealing out the potential contaminated ambient environment (“closed-loop” cooling). In cases where the ambient air is near room temperature (70-85 degrees Fahrenheit) and when there is not a threat of rain or splashing liquids present outside the enclosure, a filtered fan system is used to maintain a constant flow of filtered ambient air through the enclosure. These filtered fan systems typically are less costly than closed-looped systems and simply employ a fan which induces the cooler ambient air through a filter media into the enclosure, therefore creating a positive pressure inside the enclosure forcing the hot enclosure air out through an exhaust vent.

### BRIEF SUMMARY

In circumstances where enclosures for cooling are required, positioning an enclosure correctly may be problematic, even if heat generating components such as electronic components, servers, etc. are not yet in place. This may be due to the one or more of weight and size of the enclosure.

In summary, an embodiment provides an enclosure cart (“cart”) for transporting cooling enclosures.

In an embodiment, a cart is configured to lift a network enclosure, industrial enclosure, or any type of cabinet configured for housing electronics for a cooling solution.

In an embodiment, a cart is configured with a mechanism allowing the cart to be easily moved, such as rolled with an enclosure securely in place to a point of installation.

In an embodiment, a cart is provided with one or more of retractable stabilizing arms and retractable stabilizing legs to prevent the cart and accompanying enclosure from tipping over.

In an embodiment, once the enclosure is in place, a mechanism such as leveling casters allow for the enclosure to be lifted into place while securing the cart from moving.

In an embodiment, the enclosure is then mounted onto a wall or like structure and the leveling of the enclosure can be performed or assured.

In an embodiment, the mechanism such as leveling casters are configurable, allowing for the cart to then be repositioned from beneath the enclosure and optionally reused.

In an embodiment, a rear or back side of a cart has one or more securing tabs to secure the enclosure to the cart.

In an embodiment, the enclosure may also secured to the cart via other means, for example via ratchet bands that get cut off onsite.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE DRAWINGS

FIG. 1 illustrates a front perspective view of an example cart and enclosure according to an embodiment.

FIG. 2 illustrates an example cart and enclosure packed for shipping according to an embodiment.

FIG. 3 illustrates a back perspective view of an example cart and enclosure according to an embodiment.

FIG. 4 illustrates an example cart view with the lift raised according to an embodiment.

FIG. 5 illustrates an example method according to an embodiment.

FIG. 6 illustrates an example method according to an embodiment.

FIG. 7 illustrates an example controller according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of those embodiments.

Reference throughout this specification to “embodiment(s)” (or the like) means that a particular feature, structure, or characteristic described in connection with the embodiment is included in at least one embodiment. Thus, appearances of the phrases “according to embodiments” or “in an embodiment” (or the like) in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, etc. In other instances, well-known structures, materials, or operations are not shown or described in detail to avoid obfuscation.

As used herein, “connecting” or “coupling” includes indirect connections, logical or physical.

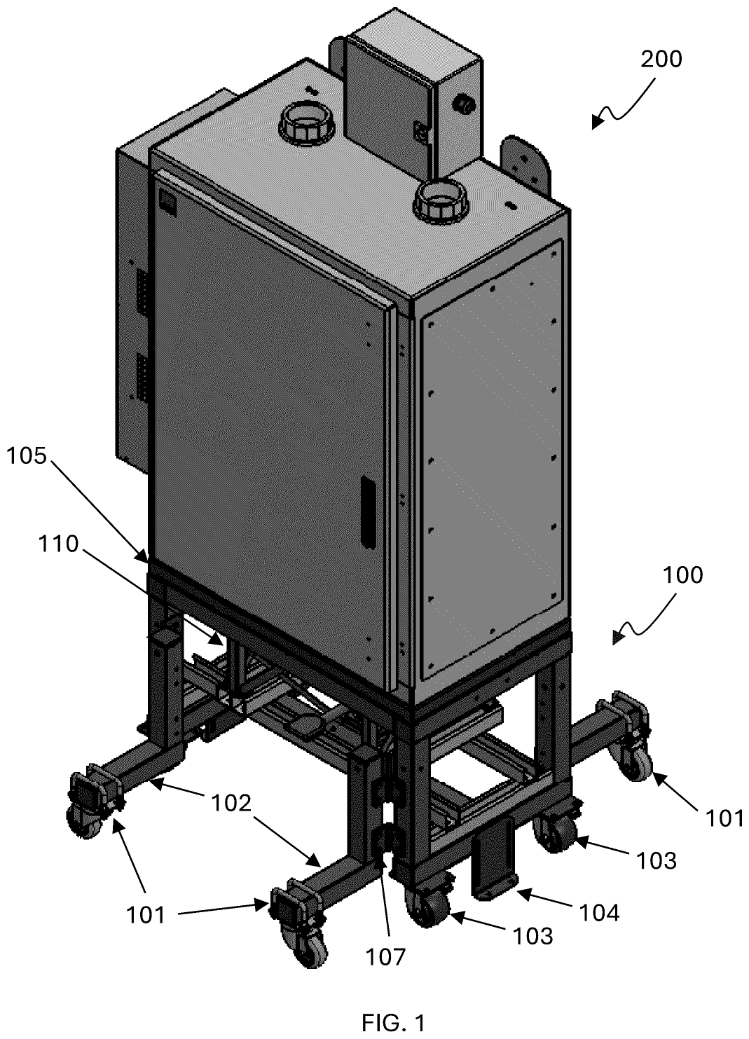

As illustrated in FIG. 1, an embodiment provides an enclosure cart (“cart”) 100 for transporting an enclosure 200. As will be discussed in detail herein, the cart 100 may include a skeletal frame forming a cuboid shape having a top and a bottom. In a further embodiment, a plate 105 may be located at the top of the skeletal frame. The plate 105 may be coupled to a lift 110 (e.g., mechanical, hydraulic, electric, etc.,) and configured to hold and lift an enclosure 200, such as a cooling enclosure or an enclosure housing telecommunications network electronics, i.e., a network enclosure. It will be apparent that the cart 100 may be utilized in combination with other enclosure types, such as an industrial enclosure, or any type of cabinet/housing.

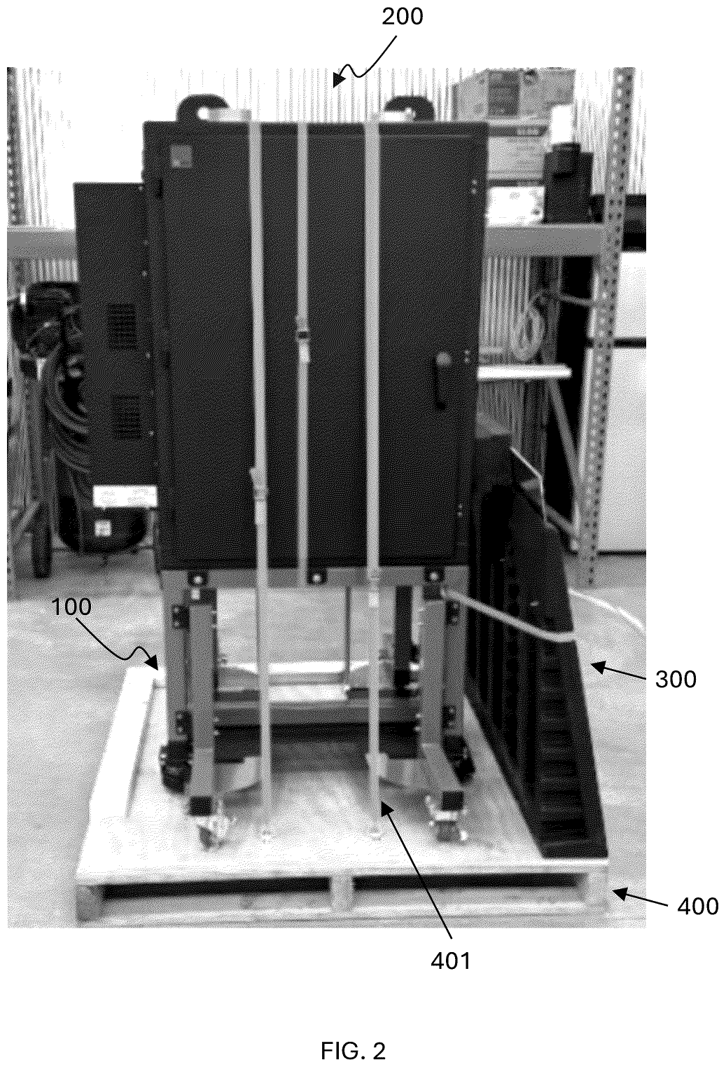

As should be understood by one of skill in the art, large mechanical systems, such as that shown in FIG. 1 are often shipped using pallets. Accordingly, in some embodiments, the cart 100 may have mounting hardware (e.g., a bracket) 104 to secure the cart to a shipping pallet. It should be understood that other types of mounting hardware may be used as well, such as, but not limited to nylon straps (see FIG. 2 at 401), mechanical clamps, and the like. As illustrated in FIG. 1, a cart 100 may be configured with a mechanism allowing the cart to be easily moved, such as casters to allow the enclosure to be rolled securely to a point of installation. In an embodiment, the cart 100 may include casters 101/103, some of which may feature adjustable height for fine vertical positioning and levelling of an enclosure once nearly in place, e.g., mounted on a wall.

Referring now to FIG. 2, the cart 100 and enclosure 200 are shown secured to a pallet 400. As can be seen in FIG. 2, although the cart 100 has caster wheels 101/103, it cannot be easily rolled off the pallet 400. Thus, in some embodiments, a ramp 300 may be included to enable the cart 100 to easily roll off the pallet. 400. Although most pallets are of uniform size, in some cases, the pallet may be taller or shorter than expected. Thus, in some embodiments, the ramp 300 may have a customizable or adjustable height.

Although the cart 100 includes a mechanism allowing the cart to be easily moved (e.g., caster wheels) it may still be difficult to move due to the large size and heavy weight of the enclosure. Accordingly, in some embodiments, and as illustrated in FIG. 1, an embodiment may include one or more of retractable stabilizing arms 102. Inclusion of such retractable arms 102 allows these components to be secured within or about the cart's 100 main footprint while in transit and deployed on site to prevent the cart and accompanying enclosure from tipping over. As may be appreciated from FIG. 1, one or more of the retractable arms 102 may include a mechanism assisting movement 101, for example a caster or levelling caster. In such an embodiment, the retractable stabilizing arms 102 may be deployed for movement of the enclosure and cart combination into place, i.e., while in transit on site. As may be appreciated, the retractable arms 102 may be replaced or used in combination with fixed or semi-fixed stabilizing arms (not shown).

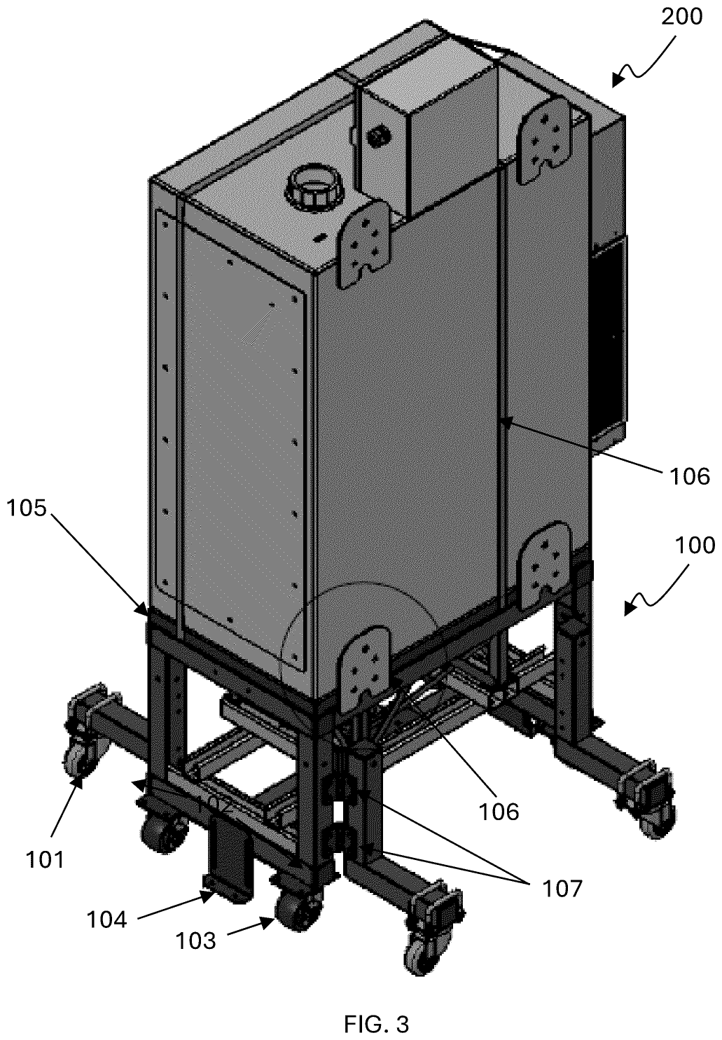

FIG. 3 provides a view in which an enclosure 200 is placed atop a cart 100 on the plate 105. In one example, the enclosure 200 may be secured by a securing mechanism 106, such as securing tabs with holes that align with holes in the enclosure and allow the enclosure to be bolted to the cart, rachet straps or bands, etc. As shown in FIG. 3, the top of the cart 100 may feature a plate 105 or similar structure. In some embodiments, the plate 105, which holds an enclosure in place, may be provided with a mechanism for preventing damage and/or slippage of the enclosure. In one embodiment, such a mechanism may comprise a padded top plate 105, for example coated with rubber or similar compressible, non-slip material. In some embodiments, and as shown in FIG. 1 and FIG. 3, the cart 100 may include hinges 107 for the one or more of retractable arms 102, permitting the retractable arms to be swung about the hinge and positioned into place.

Protective endcaps may be supplied, e.g., to prevent damage to the component (e.g., retractable arm) or damage to a structure in the surrounding environment. In an embodiment, a suitable material for endcaps include, but is not limited to, plastic or rubber. It may be appreciated from FIG. 1 and FIG. 3 (showing the one or more of retractable arms 102 outwardly rotated about hinge(s) 107) that the one or more of retractable arms may include a movement mechanism (e.g., caster wheels 101) facilitating movement of the cart when the one or more of the retractable arms and legs are deployed in a legs-out configuration.

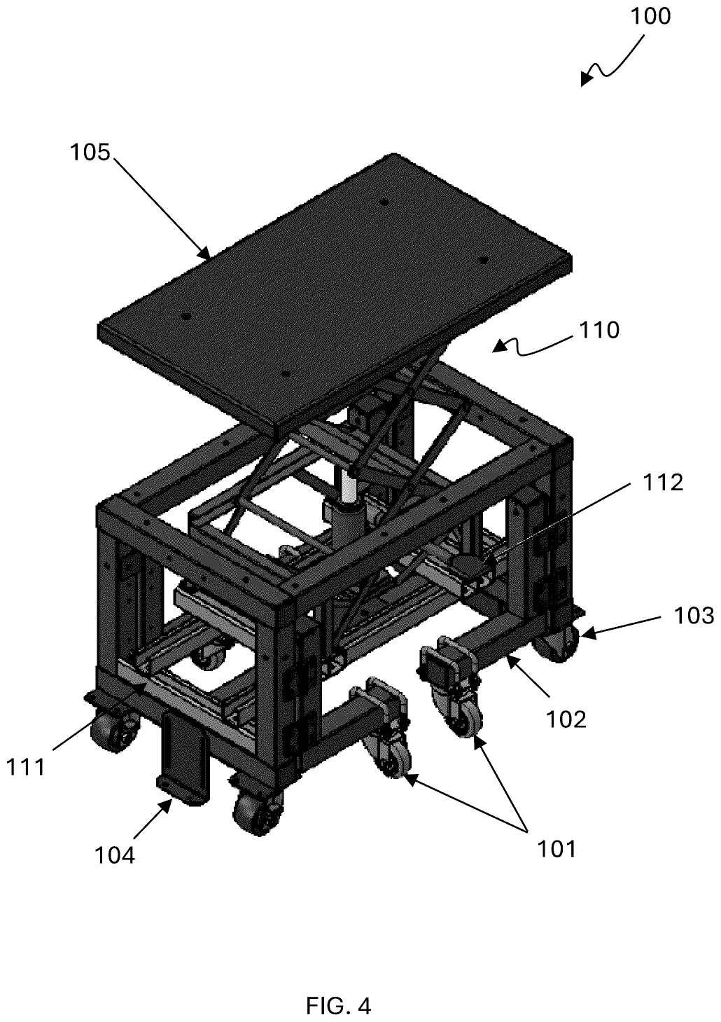

Referring now to FIG. 4, in an embodiment, a cart 100 may include a lower structure 111, for example a plate or shelf structure. In this example, the lower plate or shelf 111 may be formed in part by multiple components, such as those attached the cart's 100 main frame structure in combination with components attached to the one or more of the retractable arms 102, as for example illustrated in the transition between FIG. 4 and FIGS. 1 and 3. For example, part of the lower 111 structure may be formed or completed when the one or more of the retractable arms 102 are configured in the closed-leg configuration.

A cart 100 according to an embodiment may have a relatively open characteristics, as for example illustrated by FIG. 4. Here it can be appreciated that the lower portion 111 of the cart is unencumbered by structural components, allowing free space to be utilized as desired, e.g., to transport additional materials. Similarly, FIG. 2 provides a front view of the example cart showing a generally open air or skeletal structure.

As indicated herein, FIG. 1 provides an example of a cart 100 in which the one or more of retractable arms 102 are deployed in a leg-open configuration with casters 101 or similar mechanism applied to the ends thereof, permitting the cart to be repositioned and moved laterally with increased stability. In a further embodiment, one or more of the caster wheels 101/103 may include a leveling device for vertically leveling, e.g., where levelling casters are employed at one or more locations.

Referring now to FIG. 1 and FIG. 3 a side view of an example cart with the retractable arms 102 in the open configuration where the one or more of retractable arms are opened relative to the main portion or skeletal structure of the cart, e.g., via rotating about hinge(s) as described herein. As may be appreciated from review of the description and the figures, the one or more retractable arms 102 may be positioned in a variety of intermediate configurations, such as angular ranges between the open-leg and closed-leg configurations, such as between the angular range of 1 degree and 180 degrees (without limitation to other ranges being utilized). Certain angular ranges may be encouraged, required, or preset, e.g., using a biasing mechanism, stop mechanism, locking mechanism, etc.

In some embodiments, such as shown in FIG. 4, the cart 100 may have a lift mechanism 110. The lift 110 may be any kind of lift, such as, a hydraulic lift system, a fully mechanical lift system, air lift system, electrical lift system, and the like. As discussed herein, the lift 110 enables the enclosure 200 to be raised or lowered to accommodate the final mounting height. Stated differently, the lift 110 enables a user to safely raise or lower the enclosure 200 without the need for multiple people to lift. In some embodiments, such as shown in FIG. 4, the lift system 110 may include an actuator, such as foot pump 112. Actuator 112 enables a user to raise or lower the lift. By way of example and not limitation, lift 110 may include a hydraulic jack which acts to raise plate 105 via actuation of a foot pump. As disclosed herein, lift 110 may be any feasible lifting system, and thus, the actuator may vary based on the specifics of the selected lift system. For example, in some embodiments, a crank may be used to raise or lower the lifting 110. In another example, the lift 110 may have adapters to allow it to be powered by electricity or air compressor.

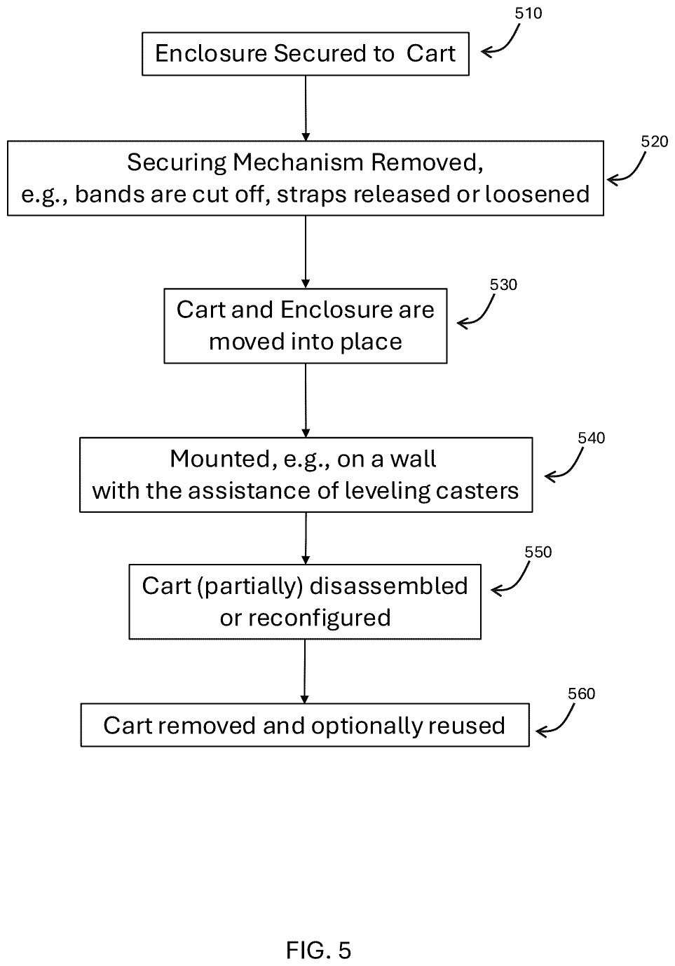

Referring to FIG. 5, in an embodiment, an enclosure may be secured to a cart in 510. An enclosure may be moved into place in 530, before or after a securing item(s) such as bands, straps, etc. are removed in 520. The enclosure is then mounted onto a wall or like structure and the leveling of the enclosure can be performed or assured, as indicated in 540. In an embodiment, the cart may be partially disassembled or reconfigured, e.g., the mechanism such as leveling casters may be retracted after the enclosure is secured to a wall, as indicated in 550, allowing for the cart to then be repositioned from beneath the enclosure and optionally reused, as indicated in 560.

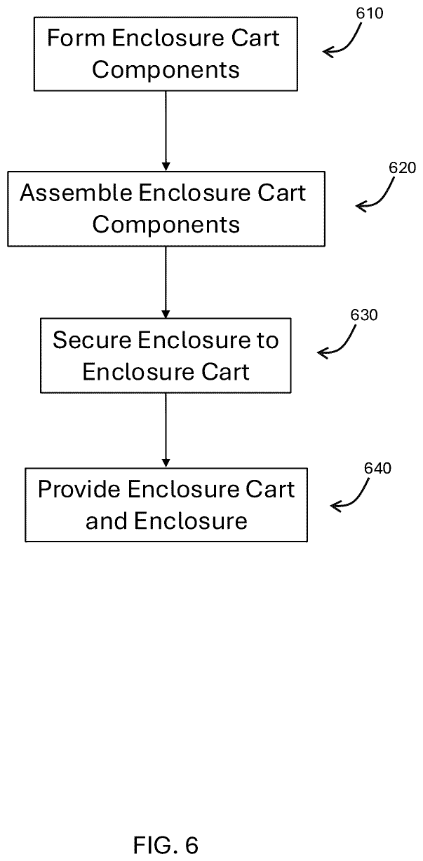

An embodiment may include a method of providing a cart for transporting enclosures for cooling solutions, as indicated in FIG. 6. For example, enclosure cart component(s) as described herein may be formed, as indicated in 610. For example, components such as skeletal components may be formed from steel tubing. In an embodiment, cart components may be used to form or assemble a cart, as indicated in 620. For example, a base skeletal structure may be formed and supplied with hinges and one or more of retractable arm and legs. One or more casters or leveling casters may be applied, connected, or secured to other components, such as the skeletal structure, retractable arms or legs, etc. In an embodiment, the cart may be combined with or secured to an enclosure, as shown in 630. In an embodiment, the enclosure may be employed or supplied with one or more of internal components, such as a digital controller, and one or more external components, such as a cooling solution, for example an air conditioner, a filtered fan system, a heat exchanger, a combination of the foregoing, etc. In an embodiment, the cart and enclosure combination may be provided, as indicated in 640.

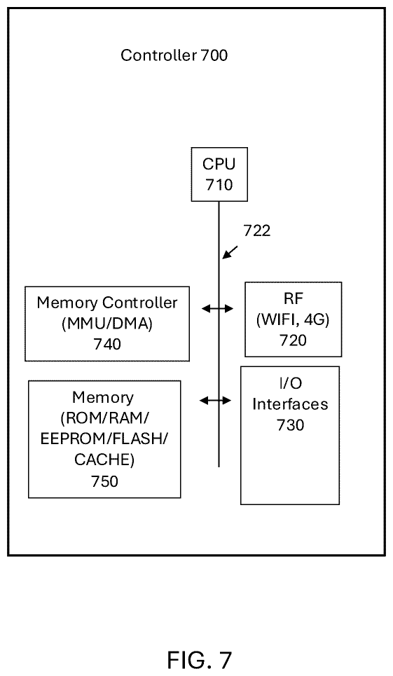

Turning to FIG. 7, an example device that may be used in implementing one or more embodiments includes a controller 700 in the form of a microcontroller computing device or a control panel.

Controller 700 may execute program instructions or code or operate using dedicated circuitry configured to process data or signals and perform other functionality of the embodiments. Components of controller 700 may include, but are not limited to, a processing unit, which may take a variety of forms such as a central processing unit (CPU) 710, a programmable circuit or other programmable hardware, non-programmable hardware, a combination of the foregoing, etc., a system memory controller 740 and memory 750, as well as a system bus 722 that couples various system components including the system memory 750 to the processing unit 710. It is noted that in certain implementations, controller may take a reduced or simplified form, such as a micro-control unit implemented in a control panel of a cooling system, or even non-programmable hardware such as a series of relays, switches, or circuits, where certain of the components of controller are omitted or combined, or the “controller” is formed by one or more of these other elements.

Controller 700 may include or have access to a variety of non-transitory computer readable media. Memory 750 may include non-transitory computer readable storage media in the form of volatile and/or nonvolatile memory devices such as read only memory (ROM) and/or random-access memory (RAM). By way of example, and not limitation, memory 750 may also include an operating system, application programs, other program modules, and program data. For example, memory 750 may include application programs such as variable speed control software and/or air conditioner operational software for implementing various cooling and/or heating protocols, as described herein. Data may be transmitted by wired or wireless communication elements 730, 720, respectively, e.g., to or from first device to another device, e.g., communication between a remote device or system such as controller 700.

A user can interface with (for example, enter commands and information) the controller 700 through input devices such as a touch screen, keypad, etc. A monitor or other type of display screen or device may also be connected to system bus 722 via an interface. Controller 700 may operate in a networked or distributed environment using logical connections to one or more other remote computers or databases. The logical connections may include a network, such local area network (LAN) or a wide area network (WAN) but may also include other networks/buses. In one example, controller 700 is remotely controllable via Ethernet.

It should be noted that various functions described herein may be implemented using processor executable instructions stored on a non-transitory storage medium or device or using dedicated circuitry or circuits. A non-transitory storage device may be, for example, an electronic, electromagnetic, or semiconductor system, apparatus, or device, or any suitable combination of the foregoing. More specific examples of a non-transitory storage medium include the following: a portable computer diskette, a hard disk, a random-access memory (RAM), a read-only memory (ROM), an erasable programmable read-only memory (EPROM or Flash memory), a portable compact disc read-only memory (CD-ROM), a solid-state drive, or any suitable combination of the foregoing. In the context of this document “non-transitory” media includes all media except non-statutory signal media.

Program code embodied on a non-transitory storage medium may be transmitted using any appropriate medium, including but not limited to wireless, wireline, optical fiber cable, RF, etc., or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN) or the connection may be made through other devices (for example, through the Internet using an Internet Service Provider), through wireless connections, or through a hard wire connection, such as over a USB or another power and data connection.

It is worth noting that while specific elements are illustrated in the figures, and a particular ordering or organization of elements or steps has been illustrated, these are non-limiting examples. In certain contexts, two or more elements or steps may be combined into an equivalent element or step, an element or step may be split into two or more equivalent elements or steps, or certain elements or steps may be re-ordered or re-organized or omitted as appropriate, as the explicit illustrated examples are used only for descriptive purposes and are not to be construed as limiting.

The dimensions described in this specification or any figures or materials accompanying this specification are in inches unless indicated otherwise and are provided by way of example only.

If used herein, the term “about” shall include ordinary rounding from a base number to a nearest significant digit, for example a base number of 10.1 may be rounded to 10.0 and 10.2.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected by one skilled in the art without departing from the scope or spirit of the disclosure.

What is claimed is:

1. A cart, comprising:
a skeletal frame forming a cuboid shape having a top and a bottom;
at least one stability arm coupled to the skeletal frame, wherein the at least one stability arm is configurable in an extended position and a retracted position;
one or more adjustable leveling casters secured to and supporting at least a portion of the skeletal frame;
a lift housed within the skeletal frame;
a plate located at the top of the skeletal frame and coupled to the lift; and
an actuation device operatively coupled to the lift system, the actuation device configured to modify the height of the lift based on a user input.

2. The cart of claim 1, further comprising: an enclosure contacting a top surface of the plate; and removably coupled to the plate using a fastener.

3. The cart of claim 1, wherein the skeletal frame is configured to attach to a pallet for shipping.

4. The cart of claim 3, further comprising a ramp having a customizable height, the ramp configured enable the skeletal frame to be moved off the pallet.

5. The cart of claim 1, wherein one of the one or more adjustable leveling casters is coupled to a bottom of the skeletal frame.

6. The cart of claim 5, wherein the one or more adjustable leveling casters comprise a leveling mechanism.

7. The cart of claim 1, further comprising a caster coupled to each of the at least one stability arm.

8. The cart of claim 1, wherein the actuation device comprises a hydraulic pump.

9. An apparatus, comprising:
a cart comprising:
a skeletal frame forming a cuboid shape having a top and a bottom;
at least one stability arm coupled to the skeletal frame, wherein the at least one stability arm has an extended position and a retracted position;
one or more adjustable leveling casters secured to and supporting at least a portion of the skeletal frame;
a lift housed within the skeletal frame;
a plate located at the top of the skeletal frame and coupled to the lift; and
an actuation device operatively coupled to the lift system, the actuation device configured to modify the height of the lift based on a user input; and
an enclosure contacting a top surface of the plate, and removably coupled to the plate using a fastener.

10. The apparatus of claim 9, wherein the skeletal frame is configured to attach to a pallet for shipping.

11. The apparatus of claim 10, further comprising a ramp having a customizable height, the ramp configured to create a transition surface for moving the skeletal frame off the pallet.

12. The apparatus of claim 9, wherein one of the one or more adjustable leveling casters is coupled to a bottom of the skeletal frame.

13. The apparatus of claim 12, wherein the one or more adjustable leveling casters comprise a leveling mechanism.

14. The apparatus of claim 9, further comprising a caster coupled to each of the at least one stability arm.

15. The apparatus of claim 9, wherein the actuation device comprises a hydraulic pump.

16. A system comprising:
the apparatus of claim 9; and
a ramp having a customizable height, the ramp configured to create a transition surface for moving the skeletal frame off the pallet.
